(19) United States
(12) Patent Application Publication
(10) Pub. No.: US 2014/0223235 A1
(43) Pub. Date: Aug. 7, 2014

(54) SYSTEM AND METHOD FOR REMOTELY MONITORING MACHINES

(71) Applicant: Caterpillar Global Mining LLC, South Milwaukee, WI (US)

(72) Inventors: Sai Praveen Gundlapalli, Chennai (IN); Preethi Ayyamperumal, Theni (IN); Ramakrishna V. Challa, Narasaraopet (IN); Krithika Balasubramanian, Chennai (IN)

(73) Assignee: Caterpillar Global Mining LLC, South Milwaukee, WI (US)

(21) Appl. No.: 14/245,430

(22) Filed: Apr. 4, 2014

(51) Int. Cl. H04L 12/26

(52) U.S. Cl. CPC H04L 43/0823
USPC 714/27

(57) ABSTRACT

A method for remotely monitoring one or more machines is disclosed. One or more machines available for communicating with a portable device over a wireless network are detected using the portable device. Fault data associated with each of the one or more machines is received. The fault data includes severity data indicative of a severity level associated with the fault data. Further, a list of the one or more machines is displayed on a display of the portable device based on the severity data.

### TECHNICAL FIELD

The present disclosure relates to a system and method for remotely monitoring machines.

### BACKGROUND

Multiple number and types of machines operate within a worksite. All of these machines may encounter one or more faults and failures associated with them. Some of these failures may not be very critical for the machine's performance, whereas some faults may be highly critical for the machine's performance. Such high critical failures may need immediate attention by an operator and/or service personnel in order to rectify the fault and/or replace a component within the machine which has failed.

Generally, these faults in the machine may be monitored periodically by physically connecting the machine to a laptop or a computer and downloading the on-board information. However, physically connecting every machine in the worksite may be a time consuming and tedious task. Also, the service personnel may not know which machine has high criticality failures and which machine needs to be serviced on priority, thereby resulting in undesired downtime of machines.

United States Publication Number 2012/0252364 relates to a system and method for controlling a vehicle telematics unit via a smart phone using the steps of: storing a software application for remotely controlling the telematics unit at the smart phone; using the stored software application to communicatively connect the smart phone with the telematics unit via a short-range wireless communication link; receiving data from the telematics unit that is used to display a menu of telematics service selections at the smart phone; receiving a telematics service selection from a vehicle occupant at the smart phone that is chosen from one of the displayed telematics service selections; and transmitting a command that controls at least one function of the vehicle based on the received telematics service selection from the smart phone to the telematics unit over the short-range wireless communication link.

### SUMMARY OF THE DISCLOSURE

In one aspect of the present disclosure, a method for remotely monitoring one or more machines is disclosed. One or more machines available for communicating with a portable device over a wireless network are detected using the portable device. Fault data associated with each of the one or more machines is received. The fault data includes severity data indicative of a severity level associated with the fault data. Further, a list of the one or more machines is displayed on a display of the portable device based on the severity data.

In another aspect, a system for remotely monitoring one or more machines is provided. The system includes one or more machines capable of communicating over a wireless network. Further, the system includes a portable device having a controller communicatively coupled to the one or more machines over the wireless network. The controller is configured to detect the one or more machines for communicating with the one or more machines over the wireless network. Further, the controller is configured to receive fault data associated with each of the one or more machines. The fault data includes severity data indicative of a severity level associated with the fault data. Furthermore, the controller is configured to display a list of the one or more machines on a display of the portable device based on the severity data.

In a yet another aspect, a computer program product including a computer usable storage medium having computer usable program code embodied thereon for remotely monitoring one or more machines, is provided. The computer program product includes a computer usable program code configured to detect, using a portable device, one or more machines available for communicating with the one or more machines over a wireless network. Further the computer program product includes a computer usable program code configured to receive fault data associated with each of the one or more machines. The fault data includes severity data indicative of a severity level associated with the fault data. Furthermore, the computer program product includes a computer usable program code configured to display a list of the one or more machines on a display of the portable device based at least in part on the severity data.

Other features and aspects of this disclosure will be apparent from the following description and the accompanying drawings.

### BRIEF DESCRIPTION OF THE DRAWINGS

FIG. 1 is an exemplary system for remotely monitoring a plurality of machines, according to an embodiment of the present disclosure;

FIG. 2 is a block diagram of an exemplary portable device in communication with a machine within the system for remotely monitoring the plurality of machines, according to an embodiment of the present disclosure;

FIG. 3 illustrates an exemplary interface for scanning displayed on the portable device;

FIG. 4 illustrates an exemplary interface showing a list of machines displayed on the portable device; and

FIG. 5 is a flowchart of an exemplary method for remotely monitoring the plurality of machines, according to an embodiment of the present disclosure.

### DETAILED DESCRIPTION

The present disclosure relates to a system and a corresponding method for remotely monitoring a plurality of machines. The detailed description of exemplary embodiments in the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this system can also be employed in a variety of other applications. Thus, the detailed description herein is presented for purposes of illustration only and not of limitation. For example, the steps recited in any of the method or process descriptions may be executed in any order and are not limited to the order presented.

The present disclosure is described herein with reference to block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, prompts, etc. Practitioners will appreciate that the illustrated steps described herein may comprise in any number of configurations including the use of windows, hypertexts, hyperlinks, popup windows, prompts and the like. It should be further appreciated that the multiple steps as illustrated and described may be combined into single windows but have been expanded for the sake of simplicity. In other cases, steps illustrated and described as single process steps may be separated into multiple windows but have been combined for simplicity.

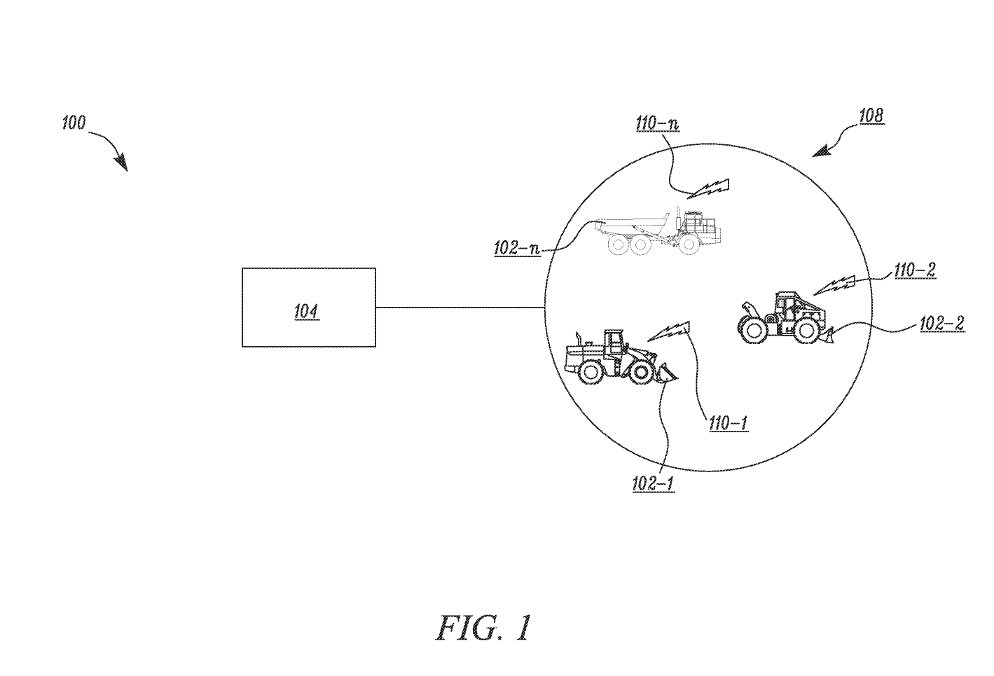

FIG. 1 illustrates a system 100 for remotely monitoring a plurality of machines 102-1, 102-2 . . . 102-n, hereinafter collectively referred to as the machines 102. The system 100 includes the machines 102, and a portable device 104. In an exemplary embodiment, the portable device 104 may be a handheld mobile device, such as a cellular phone. In various alternative embodiments, the portable device 104 may be a laptop, a tablet PC, a personal digital assistant (PDA), etc. In an embodiment, the portable device 104 may be a computing device of any one of the machines 102 or a different machine. It may be contemplated, that the portable device 104 may be used by a user such as an operator of the machines 102, and/or a service personnel etc., to monitor the machines 102.

In an exemplary embodiment, the machines 102 may be the machines 102 operating within a worksite 108, such as a mine site, a construction site, landscaping sites etc. In alternative embodiments, the machines 102 may be the machines 102 operating at multiple worksites 108. The machines 102 may be of similar or different types. Examples of different types of the machines 102 may include a motor grader, a dozer, a hydraulic excavator, a haul truck, an engine, a power system machine, etc. Further, each of the machines 102 may be capable of communicating wirelessly.

In an exemplary embodiment, each of the machines 102 may have a respective wireless network 110 associated therewith. In this case, the communication between the machines 102 and the portable device 104 happens over the respective wireless networks 110. Examples of the wireless networks 110 include a Wi-Fi network, a Zigbee network, a worldwide interoperability for microwave access (WiMAX) network and the like. In another embodiment, the communication between the machines 102 and the portable device 104 may happen over a common wireless communication network (not shown in FIG. 1), such as, a cellular communication network, a satellite communication network or any other suitable network.

The portable device 104 is configured to scan and detect the machines 102 available for communicating with the portable device 104. In one embodiment, the portable device 104 scans for wireless networks 110 associated with the machine 102 for communicating with the machines 102. The portable device 104 is configured to receive various fault data associated with each of machines 102 over the respective wireless networks 110 of the machines 102. The portable device 104 is configured to receive a user input of a selected machine 102 from amongst all the machines 102 available for communication based on the fault data. Furthermore, the portable device 104 is configured to access on-board information of the selected machine, for example, machine 102-n, by connecting to the respective wireless network 110-n. In some embodiments, the data exchange between the portable device 104 and the machines 102 as described herein happens over the common communication network instead of respective wireless networks 110.

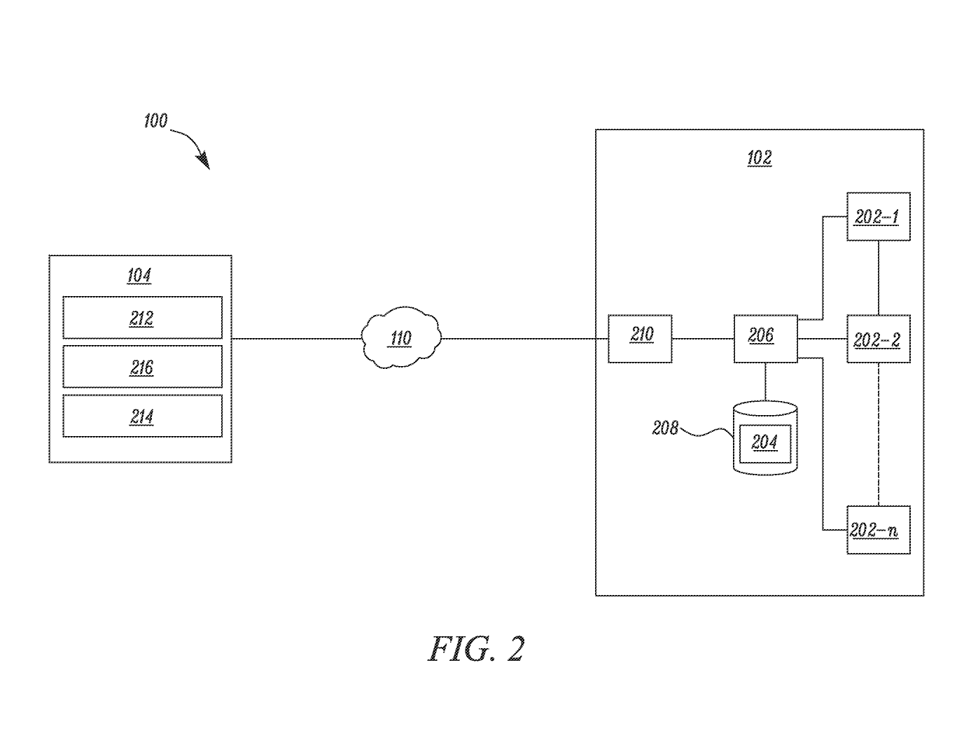

Various embodiments are now described with respect to an example implementation where the wireless networks 110 are Wi-Fi networks; though it will be appreciated that suitable modifications can be made for other types of wireless networks. FIG. 2 illustrates an exemplary block diagram of the portable device 104 in communication with a machine 102 within the system 100 for remotely monitoring the plurality of machines 102. As illustrated, each of the machines 102 (only one is shown in FIG. 2) includes a plurality of control modules 202-1, 202-2 . . . 202-n, hereinafter collectively referred to as the control modules 202 associated with various components of the machine 102. Examples of the various control modules 202 may include, but may not be limited to, an engine control module associated with an engine of the machine 102, a transmission control module associated with a transmission system of the machine 102, drivetrain control module associated with a drivetrain of the machine 102, brake control module associated with a braking system of the machine 102, and body control module associated with the body of the machine 102 such as for controlling door locks, electronic windows, headlamps and so on.

Each of the control modules 202 may be configured to detect one or more faults and/or failures associated with the respective machine components. The data corresponding to the failures may be stored as fault data 204. In an embodiment, the fault data 204 may include a count of failures of the machine 102. The failures may include failures in one or more physical components of the machine 102. Examples of such failures may include failure associated with door locks, or failure of a component within the engine, such as engine oil pressure sensor, or failure of a component within the transmission system of the machine 102, such as engine fan speed control solenoid, etc. The failures may also correspond to operational parameter values exceeding and/or falling below certain limits on values of the operational parameters. The one or more operational parameters may include speed of the machine 102, speed of the engine of the machine 102, engine coolant temperature, intensity of headlight from the headlamps, etc. Thus, for example, if the engine coolant temperature becomes greater than a permissible limit, this may be treated as a failure in the machine 102.

In an exemplary embodiment, the fault data 204 may further include a severity level associated with each of the failures within the fault data 204. The severity level is indicative of a criticality of the failures of the machine 102. For example, the severity level may be a rating such as Level 1 severity corresponding to low criticality failures, Level 2 severity corresponding to medium criticality failures and Level 3 corresponding to high criticality failures. The severity levels may be associated with each of the failures detected by the various control modules 202 of the machine 102. For example, the engine control module may detect a failure in the engine oil pressure sensor with severity level of 3, indicating that the engine oil pressure sensor needs immediate attention. Similarly, the engine control module may detect that a failure corresponding to the engine coolant temperature with severity level of 2 indicating a medium criticality associated with this failure. A person skilled in the art will appreciate that indication of the severity level by Level 1, Level 2 and Level 3 is merely described for illustrative purposes and other ways to indicate the severity level are also possible. For example, the severity level may be indicated by High, Medium and Low. Further, more than three or less than three levels of severity may be defined.

In an exemplary embodiment, the machine 102 may include a gateway control module 206 operatively connected to the control modules 202 via respective communication links, such as controller area network (CAN) buses. Other examples of the communication links between the gateway control module 206 and the control modules 202 are Ethernet and Flex Ray. The gateway control module 206 may be configured to receive the fault data 204 along with the severity data associated therewith, from each of the control modules 202 associated with the machine 102.

Further, the gateway control module 206 is configured to store the received fault data 204 into a storage module 208. The storage module 208 may be internal to the machine 102 or external to the machine 102. In one example implementation, the storage module 208 is a non-volatile memory. In an embodiment, the storage module 208 may be a database, such as, a relational database, a hierarchical database, a graphical database, an object-oriented database, and/or based upon other database configurations. In another embodiment, the storage module 208 may be a file-based storage system.

In an embodiment of the present disclosure, the machine 102 may include a network module 210 configured to host the individual wireless network 110, for example, a Wi-Fi network, of the machine 102. In an exemplary embodiment, the network module 210 may be hardware communicatively coupled to the gateway control module 206. For example, the network module 210 may be a Universal Serial Bus (USB) wireless dongle configured to generate an access node via which an external network node may communicate with the wireless network 110 of the machine 102. In another embodiment, the network module 210 may be a software-enabled component within the gateway control module 206. In a further embodiment, the network module 210 and the gateway control module 206 may be hardware and/or software-enabled components of a network manager, not shown. It may be contemplated that the gateway control module 206 is a centralized control module of the machine 102 acting as an interface between the control modules 202 of the machine 102 and the portable device 104, and the network module 210 performs under the direction of the gateway control module 206. In another embodiment, the network control 210 is responsible for directing all communication with the portable device 104 and the gateway control module 206 performs under the control of the network module 210 to collect the fault data from the control modules 202 and/or the storage module 208 and pass the fault data to the network module 210.

The gateway control module 206 is configured to broadcast one or more identifiers associated with the machine 102 via the network module 210. In an exemplary embodiment, the one or more identifiers may be network identifiers, such as service set identifiers (SSID) associated with the individual wireless network 110 of the machine 102. According to one example implementation, the gateway control module 206 broadcasts one hidden SSID and different SSIDs corresponding to different types of users. For example, one SSID may correspond to a dealer, one SSID may correspond to service personnel, one SSID may correspond to a customer, and one SSID may correspond to an operator. Different types of users are able to access the machine 102 by supplying the corresponding SSID to connect to the corresponding wireless network 110.

As illustrated in FIG. 2, the portable device 104 may include a controller 212 and a display 214 operatively connected to the controller 212. In an exemplary embodiment of the present disclosure, the portable device 104 may include an application 216 installed thereon and displayed using the display 214. The application 216 is communicatively coupled to the controller 212 of the portable device 104. In an exemplary embodiment, the controller 212 may be a processer of the portable device 104 running the application 216. The application 216 may be an inbuilt application stored within the portable device 104. In an alternative embodiment, the application 216 may be downloaded from an external source and installed on the portable device 104. Although, the application 216 is shown as residing on the portable device 104 in FIG. 2, in an alternative embodiment, the application 216 may be accessible over a network, for example, the Internet, through a web browser residing on the portable device 104. The application 216 may be provided by an entity deploying the system 100 including the machines 102 or may be provided by a third party provider. The application 216 is configured to facilitate a user of the portable device 104 to remotely monitor the machines 102. It may be contemplated that the controller 212 is configured to perform a number of tasks related to remotely monitoring the machines 102 in response to user inputs received via a user interface of the application 216 displayed on the display 214. Further, the portable device 104 includes a transceiver (not shown) configured to connect and communicate with the respective machines 102 over the respective individual wireless networks 110.

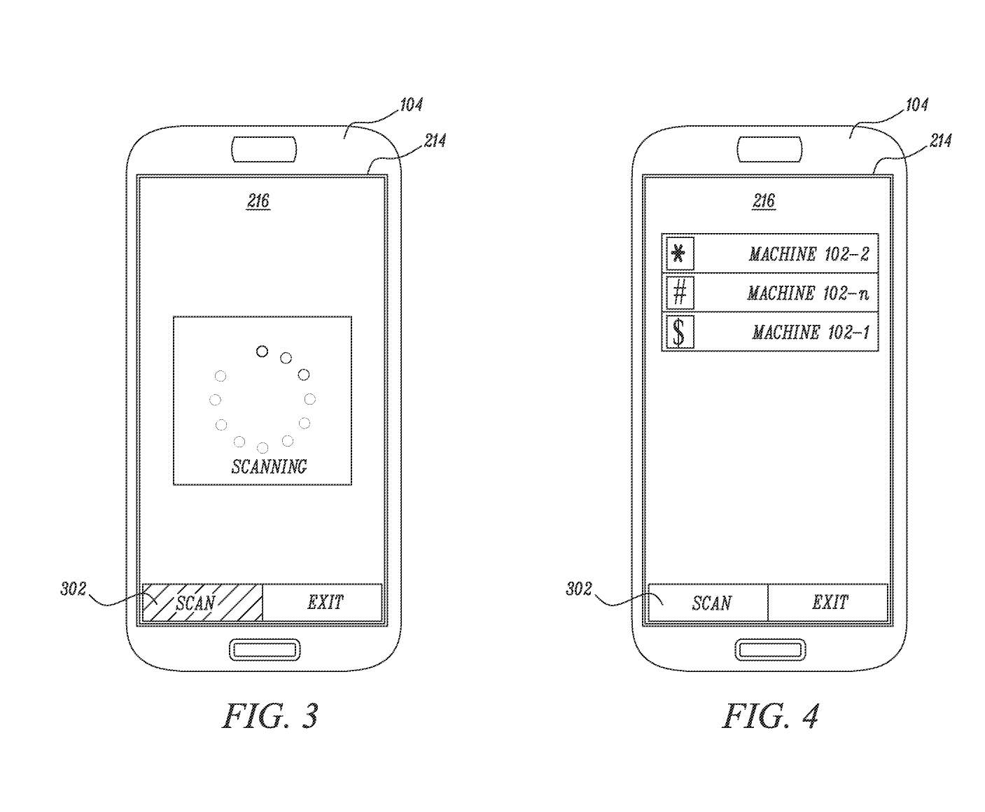

In an embodiment, the controller 212 is configured to scan for various wireless networks 110 within a vicinity of the portable device 104. As shown in FIG. 3, when the application 216 is initiated, and a “scan” command is activated by the user by pressing a “SCAN” button 302, the controller 212 in response may scan for access nodes associated with the various wireless networks 110 available for communication within the vicinity of the portable device 104. The controller 212 is configured to detect the machines 102 based on the unique identifiers associated with the respective machines 102. For example, the controller 212 may detect the SSIDs broadcasted by the gateway control module 206 of each of the machines 102. In an embodiment, the hidden SSID may be known only to a particular machine and the application 216 (and therefore, the controller 212).

Further, the controller 212 is configured to access the respective wireless networks 110 by using the corresponding hidden SSID and a password. The passwords of the wireless networks 110 may be pre-configured into the application 216, according to an embodiment. The controller 212 retrieves the pre-configured password to access the wireless networks 110. As the hidden SSID and the password for a particular wireless network 110-n are known only to the application 216, unauthorized access to the network 110-n are known only to the application 216, an unauthorized connection to the wireless network 110-n may be prevented. It may be contemplated that the password corresponding to the hidden SSID is pre-stored within the portable device 104, such as by the application 216. The network module 210 may be configured to authenticate the portable device 104 based on the hidden SSID and the password provided by the controller 212. Once the authentication is successful a connection may be established between the portable device 104 and the gateway control module 206 of the machine 102.

Further, the controller 212 is configured to request the fault data 204 associated with each of the machines 102 from the respective gateway control module 206 once the connection is established between the controller 212 and the machine 102 over the respective wireless network 110. The gateway control module 206 is configured to receive the request, from the controller 212, to provide the fault data 204 associated with the respective machine 102.

The gateway control module 206 is further configured to extract the fault data 204 from the storage module 208 and generate a count of failures and the associated severity data for the respective machine 102. For example, the count may include a count of Level 3 failures, a count of Level 2 failures and a count of Level 1 failures in the machine 102. The gateway control module 206 is further configured to provide the fault data 204 including the count of failures and the associated severity data to the controller 212 via the wireless networks 110.

Further, the controller 212 is configured to receive fault data 204 from the gateway control modules 206 of all the machines 102. In an exemplary embodiment, the fault data 204 received at the controller 212 may be:
Machine 102-1 (Level 1 failures—1; Level 2 failures—3; Level 3 failures—1);
Machine 102-2 (Level 1 failures—3; Level 2 failures—0; Level 3 failures—3);
Machine 102-n (Level 1 failures—0; Level 2 failures—4; Level 3 failures—2); and so on.

In an embodiment, the controller 212 is configured to sort the list of the wireless networks 110 (and thus, effectively the machines 102) in a descending order based on the count of failures and the severity data within the fault data 204 associated with the corresponding machines 102. For example, the controller 212 sorts the list with a wireless network of a machine having highest criticality failures on the top and a wireless network of a machine having lowest criticality failures or no failures is listed on the bottom of the list, as shown in FIG. 4 according to one example. Furthermore, as explained previously, Level 3 may indicate high criticality failures and Level 1 may indicate low criticality failures. It may be contemplated that the severity levels and the respective criticality of failures explained herein are merely exemplary and may be varied based on the types of machines 102 without deviating from the scope of the claimed subject matter. The controller 212 sorts the list of the wireless networks 110 of the machines 102 based on the criticality of failures which is further based on the severity data associated the fault data 204 of the machines 102. Therefore, in the above example, the wireless network 110-2 of the machine 102-2 is listed on top of the list followed by the wireless network 110-n (of the machine 102-n) and the wireless network 110-1 (of the machine 102-1), as shown in FIG. 4.

Furthermore, the controller 212 is configured to display the sorted list of the wireless networks 110 on the display 214. For example, the broadcasted SSIDs of the wireless networks 110 are displayed. In an exemplary embodiment, the controller 212 is configured to display a visual indicator for each of the wireless networks 110 displayed in the list. The visual indicator may be indicative of the criticality of failures associated with that machine 102. In an exemplary embodiment, the different levels of criticality of failures may be indicated by separate colors. For example, machines (for example, the machine 102-2) having highly critical failures may be indicated using red color. Similarly, machines (for example, the machine 102-n) having medium criticality failures may be indicated using yellow color and machines (for example, the machine 102-1) having no failures or less critical failures may be indicated with green color. The visual indication using colors is merely exemplary and may be displayed in a variety of ways. For example, the criticality may be visually indicated with a flag of appropriate color displayed alongside the wireless network 110. In an alternative embodiment, the visual indicator may be a symbol, such as “*” symbol associated with the machines (for example, the machine 102-2) having highly criticality failures, a “#” symbol associated with the machines (for example, the machine 102-n) having medium criticality failures, and a “$” symbol associated with the machines (for example, the machine 102-1) having no failures or less critical failures, as shown in FIG. 4.

In an exemplary embodiment, the user of the portable device 104 may provide a user input to select a machine from the list. For example, the user may select the machine 102-2 having high criticality failures which may require immediate servicing. The user may click on an SSID of the wireless network 110-2 on the display for selecting the machine 102-2. Depending upon a user type, the user may select the SSID. For example, if the user is a service person, the user selects the SSID for the service personnel. Upon selection of an appropriate SSID, the controller may prompt the user to enter an appropriate password. In a further embodiment, the user may simply click on a list item corresponding to the wireless network to be selected and the controller 212 may select a suitable SSID depending upon the user type for connecting with the wireless network 110. The controller 212 may know the user type by, for example, prompting the user to enter the user type when the application 216 is launched.

In response to the user selection of the wireless network 110-2 and entry of the password, the controller 212 may send the selected SSID and the password to the wireless network 110-2. The gateway control module 206 authenticates the portable device 104 and the user is connected to the gateway control module 206 over the wireless network 110-2. In an exemplary embodiment, the controller 212 may further prompt the user to provide login credentials associated with the user. The login credentials may be predefined for the user. The login credentials may include a username and a password. The login credentials may facilitate the controller 212 to selectively access on-board information of the selected machine 102-2 for presenting to the user. The gateway control module 206 of the selected machine 102-2 may provide the on-board information of the machine 102-2 to the controller 212. The on-board information may be different for different types of users of the portable device 104, such as if the user is a service personnel, or a vendor of the selected machine 102-2, or an operator of the selected machine 102-2, or a supervisor of the worksite 108 in which the machine 102-2 is operating.

In an embodiment, the controller 212 may be configured to access the on-board information through a web interface, such as a web page of the selected machine 102-2. The web page of the machine 102-2 may be displayed on the display of the portable device 104. It may be contemplated that the user of the portable device 104 may access the web page of the selected machine 102-2 to access the detailed fault data 204 associated with machine 102-2. Further, a servicing operation may be scheduled to rectify the faults and/or replace the respective machine components associated with the fault data 204.

### INDUSTRIAL APPLICABILITY

Many types of machines operate within a worksite. All of these machines may encounter one or more faults and failures associated with them. Generally, these faults in the machine may be monitored periodically by physically connecting the machine to a laptop or a computer and downloading the on-board information. However, the service personnel may not know which machine has high criticality failures and needs to be serviced on priority.

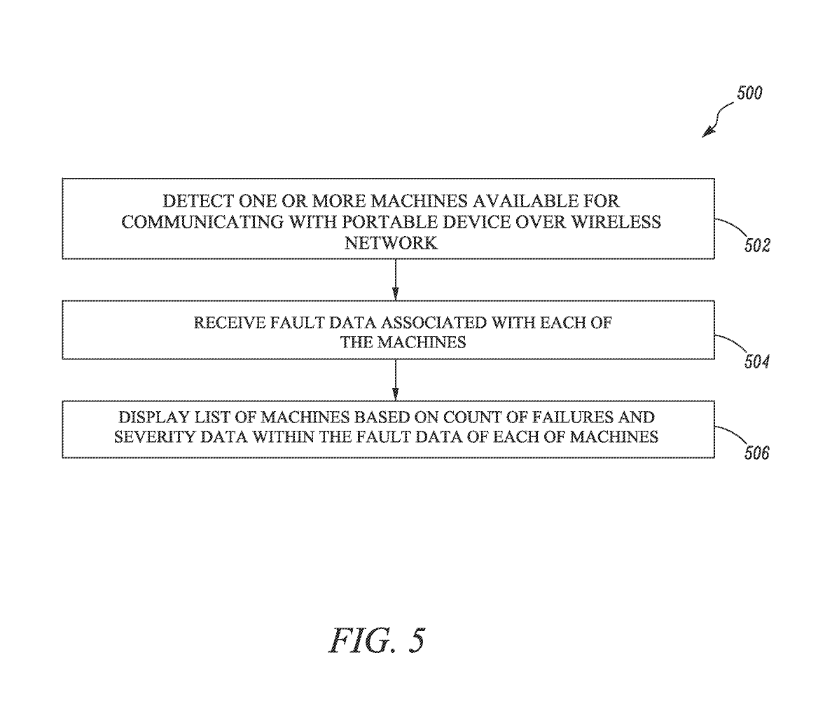

FIG. 5 illustrates a flowchart of an exemplary method 500 of remotely monitoring one or more machines 102 by using the portable device 104. Initially, at step 502, the controller 212 detects one or more machines 102 available for communicating with the machines 102 over the wireless network 110. In an exemplary embodiment, the user initiates the application 216 of the portable device 104 and activates a “scan” command 302. In response to the “scan” command 302, the controller 212 scans for all the wireless networks 110 of the machines 102 in vicinity of the portable device 104. The application 216 installed on the portable device 104 may be provided by an entity deploying the system 100 or may be provided by a third party provider, thus providing a cost effective system for monitoring the one or more machines 102.

In an embodiment, the controller 212 detects the unique identifier associated with each of the machines 102. For example, the unique identifier is a hidden SSID associated with each of the machine 102. Further, the controller 212 provides a password along with the hidden SSID of the machines 102 to authenticate the portable device 104, so that the portable device 104 may start communicating with the machine 102 via the wireless network 110. Upon successful authentication of the portable device 104, the controller 212 requests the fault data 204 associated with each of the machine 102. The hidden SSID and the password provides a secured communication of the portable device 104 with the machines 102, and thus preventing unauthorized access to the wireless network 110 of the machines 102.

At step 504, the controller 212 receives the fault data 204 associated with each of the machines 102. The fault data 204 may include the count of failures and the associated severity level for the respective machine 102. Furthermore, the controller 212 generates a list of all wireless networks 110 of the machines 102 along with their corresponding fault data 204.

At step 506, the controller 212 displays the list of the wireless networks 110 based on the count of failures and severity data within the fault data 204 of each of the machines 102. In an exemplary embodiment, the controller 212 sorts the list of the wireless networks 110 in a descending order based on the count of failures and the associated severity data. Therefore, the list shows a wireless network of a machine having highest count of highly critical failures on the top and a wireless network of a machine having the lowest count of the least critical failures or no failures on the bottom. The sorted list facilitates the user to identify the machines 102 that are of a high priority as they have high criticality failures associated with them and need immediate attention. Further, for the high priority machines 102, servicemen and labor may be accordingly distributed for optimally servicing the machines 102 to further reduce the undesired downtime.

In an embodiment, the controller 212 further displays a visual indicator indicative of the severity level of faults in each of the machines 102. Examples of visual indicators may include color code, flags of various colors, symbols, etc. The visual indicators facilitate the user to identify high priority machines having high critical failures that need immediate attention. The visual indicators may also facilitate the user to identify the high priority machines 102 which need immediate attention and/or servicing.

Furthermore, the controller 212 receives a user input indicative of a selection of the wireless network 110 (effectively, the selection of the corresponding machine 102) within the list. The selection may be done by clicking on an appropriate SSID of the wireless network 110 to be selected. In an exemplary embodiment, the user may select the machine 102 having highly critical failures, i.e., the machine 102 listed on top of the list. However, in an alternative embodiment, the list may only include visual indicators and may not be sorted in an order. In such cases, the user may identify the high priority machine 102 by using the visual indicators displayed with each of the machines 102 in the list.

In an embodiment, the controller 212 accesses the on-board information of the selected machine. For example, in response to the user input indicative of the selected machine 102 within the list, the controller 212 communicates with the selected machine over the respective wireless network 110. In an embodiment, the controller 212 provides authentication credentials, for example, the selected SSID and a password, for communicating with the selected wireless network 110. The password may be indicative of the type of the user and may be entered by the user. Further, the controller 212 provides login credentials corresponding to the user. The login credentials may include a username and a password predefined for the user. Based on the login credentials, the controller 212 may access the on-board information of the selected machine 102. The accessible on-board information may be different for different types of users depending upon the entered login credentials. The on-board information may provide detailed information related to the faults and failures associated with the selected machine 102. In an exemplary embodiment, the controller 212 accesses the on-board information through a web interface, such as a web page of the selected machine 102.

The need to enter the authentication credentials and the login credentials provide a two level authentication, thereby providing a secured way of communication between the portable device 104 and the machine 102. Since, the level of access is different for different types of users, undesired access of the on-board information is also prevented. For example, the service personnel may not need to know the confidential operational information of the machine 102 and similarly, the operator may or may not need to know the details of the various components of the machine 102. The user may access the on-board information to get details of failures of the machine 102 and accordingly schedule maintenance and servicing of the machine 102 to rectify the fault and/or replace the failed component within the machine 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for remotely monitoring one or more machines, the method comprising:
detecting, using a portable device, one or more machines available for communicating with the portable device over a wireless network;
receiving fault data associated with each of the one or more machines, the fault data including severity data indicative of a severity level associated with the fault data; and
displaying a list of the one or more machines on a display of the portable device based at least in part on the severity data.

2. The method of claim 1 further comprises scanning for wireless networks associated with the one or more machines.

3. The method of claim 1, wherein detecting the one or more machines further comprising detecting a unique identifier associated with each of the one or more machines.

4. The method of claim 1 further comprising:
accessing a wireless network associated with each of the one or more machines by using a unique identifier of each of the one or more machines and a password; and
requesting the fault data associated with each of the one or machines over the wireless network.

5. The method of claim 1, wherein receiving fault data for each of the one or more machines further comprises receiving a count and a severity level of failures in the each of the one or more machines.

6. The method of claim 5, wherein displaying the list further comprises ordering the one or more machines based at least in part on the count and the severity level of the failures associated with each of the one or more machines.

7. The method of claim 1, wherein displaying the list further comprises displaying a visual indicator for each of the one or more machines, the visual indicator being indicative of the severity level of faults in the machine.

8. The method of claim 1 further comprising:
selecting a machine from the displayed list of the one or more machines based on the severity level associated with the fault data of the selected machine;
accessing on-board information of the selected machine over a wireless network associated with the selected machine.

9. A system for remotely monitoring one or more machines, the system comprising:
one or more machines capable of communicating over a wireless network; and
a portable device having a controller communicatively coupled to the one or more machines over the wireless network, the controller configured to:
detect the one or more machines for communicating with the portable device over the wireless network;
receive fault data associated with each of the one or more machines, the fault data including severity data indicative of a severity level associated with the fault data; and
display a list of the one or more machines on a display of the portable device based at least in part on the severity data.

10. The system of claim 9, wherein the controller is further configured to scan for wireless networks associated with the one or more machines.

11. The system of claim 9, wherein the controller is configured to detect a unique identifier associated with each of the one or more machines.

12. The system of claim 9, wherein the controller is configured to:
access a wireless network associated with each of the one or more machines by using a unique identifier of each of the one or more machines and a password; and
request the fault data associated with each of the one or machines over the wireless network.

13. The system of claim 9, wherein the fault data includes a count and a severity level of failures in the each of the one or more machines.

14. The system of claim 13, wherein the controller is configured to order the one or more machines based at least in part on the count and the severity level of the failures associated with each of the one or more machines.

15. The system of claim 9, wherein the controller is configured to display a visual indicator for each of the one or more machines, the visual indicator being indicative of the severity level of faults in the machine.

16. The system of claim 9, wherein the controller is further configured to:
receive a user input indicative of a selected a machine from the displayed list of the one or more machines based on the severity level associated with the fault data of the selected machine;
access on-board information of the selected machine over a wireless network associated with the selected machine.

17. A computer program product including a computer usable storage medium having computer usable program code embodied thereon for remotely monitoring one or more machines, the computer program product comprising:
a computer usable program code configured to detect, using a portable device, one or more machines available for communicating over a wireless network;
a computer usable program code configured to receive fault data associated with each of the one or more machines, the fault data including severity data indicative of a severity level associated with the fault data; and
a computer usable program code configured to display a list of the one or more machines on a display of the portable device based at least in part on the severity data.

18. The computer program product of claim 17 further comprising a computer usable program code configured to:
access a wireless network associated with each of the one or more machines by using a unique identifier of each of the one or more machines and a password; and
request the fault data associated with each of the one or machines over the wireless network.

19. The computer program product of claim 17 further comprising a computer usable program code configured to display a visual indicator for each of the one or more machines, the visual indicator being indicative of the severity level of faults in the machine.

20. The computer program product of claim 17 further comprising a computer usable program code configured to:
select a machine from the displayed list of the one or more machines based on the severity level associated with the fault data of the selected machine;
access on-board information of the selected machine over a wireless network associated with the selected machine.
